(19) United States
(12) Patent Application Publication
(10) Pub. No.: US 2019/0125078 A1
(43) Pub. Date: May 2, 2019

(54) MOUNTING DEVICE AND DOMESTIC APPLIANCE

(71) Applicant: BSH Hausgeräte GmbH, Munich (DE)

(72) Inventors: Thomas Knoeller, Neusäß (DE); Tobias Schmidt, München (DE); Ralf Grobleben, Bretten (DE); Claudia Valenti-Zendel, Weyarn (DE); Verena Busalt, Altenmarkt (DE); Jacob Lechner, Altenmarkt (DE)

(21) Appl. No.: 16/091,114

(22) PCT Filed: Mar. 10, 2017
(86) PCT No.: PCT/EP2017/055708

§ 371 Date: Oct. 4, 2018

(30) Foreign Application Priority Data
Apr. 15, 2016 (DE) 10 2016 206 349.9

(51) Int. Cl. A47B 77/08; F16M 13/02

(52) U.S. Cl. CPC A47B 77/08; A47L 15/4265; F16M 13/02

(57) ABSTRACT

A mounting device for mounting a domestic appliance in or on a piece of furniture is configured to selectively mount the domestic appliance in or on the piece of furniture in a first installation situation, in which the mounting device is arranged flush with a front side of the piece of furniture, a second installation situation, in which the mounting device protrudes beyond the front side of the piece of furniture, or a third installation situation, in which the mounting device is set back behind the front side of the piece of furniture.

The present invention relates to a mounting device for mounting a domestic appliance in or on a piece of furniture and a domestic appliance with such a mounting device.

Domestic appliances, in particular those referred to as built-in appliances, can be built into a piece of furniture, such as a kitchen base unit for example. So-called pilaster strips can be used for this purpose. A pilaster strip is a batten-type component, which is provided on both sides of a side wall of a receiving region of the domestic appliance. The pilaster strips can be used to mount the domestic appliance in the piece of furniture. In particular the pilaster strips also define the manner in which a front face of the domestic appliance protrudes beyond or is set back from the piece of furniture.

DE 10 2005 036 815 A1 describes a domestic appliance that can be mounted in a piece of furniture with the aid of such pilaster strips.

With this in mind, one object of the invention is to provide an improved mounting device.

Therefore a mounting device for mounting a domestic appliance in or on a piece of furniture is proposed, the mounting device being designed to mount the domestic appliance in or on the piece of furniture either in a first installation situation, in which the mounting device is arranged flush with a front face of the piece of furniture, a second installation situation, in which the mounting device is arranged to protrude beyond the front face of the piece of furniture, or a third installation situation, in which the mounting device is arranged so that it is set back behind the front face of the piece of furniture.

“Flush” means that a front face of the mounting device is arranged in a shared plane with the front face of the piece of furniture. “Protruding” means that the front face of the mounting device and the front face of the piece of furniture are arranged in different planes, the plane of the mounting device being in front of the plane of the piece of furniture. “Set back” means that the front face of the mounting device and the front face of the piece of furniture are arranged in different planes, the plane of the mounting device being behind the plane of the piece of furniture. The first installation situation can be referred to as “flush”, the second installation situation as “proud” and the third installation situation as “hidden”. The piece of furniture can be for example a kitchen unit, in particular a kitchen base unit. The domestic appliance is preferably arranged in the piece of furniture. The piece of furniture can form a recess for the domestic appliance. The domestic appliance is in particular a built-in domestic appliance. The domestic appliance preferably has a door with a front face. In the first installation situation and in the second installation situation the mounting facility is arranged flush with the front face of the door. The mounting device is in the manner of a construction kit, in other words the mounting device comprises a number of parts which can be combined with one another according to the desired installation situation. Because the mounting device allows different installation situations using as many identical parts as possible, the piece of furniture can be mounted particularly easily and quickly without additional parts which are each assigned to just one installation situation respectively.

According to one embodiment the mounting device also comprises a pilaster strip support, which can be fastened to a side wall of a receiving region of the domestic appliance.

The pilaster strip support is preferably a single-piece sheet metal part. The pilaster strip support can be suspended in or clipped into the side wall and/or can be screwed thereto.

According to a further embodiment the mounting device also comprises a spacer, which is configured separately from the pilaster strip support and is designed to distance the domestic appliance from the piece of furniture.

The spacer is preferably also a sheet metal part. The spacer can be suspended in or clipped into the pilaster strip support and/or can be screwed thereto. The pilaster strip support and spacer can form a support facility of the mounting device.

According to a further embodiment the spacer is U-shaped and has a first arm and a second arm, the second arm being connected to the pilaster strip support in the first installation situation and the first arm being connected to the pilaster strip support in the second installation situation.

The spacer can thus be used both for the first installation situation and for the second installation situation. The spacer can simply be turned through 180° for this. No spacer is preferably used for the third installation situation.

According to a further embodiment in the first installation situation the first arm of the spacer rests against a front face of a side wall of the piece of furniture and in the second installation situation the second arm of the spacer rests against the front face of the side wall of the piece of furniture.

Either the first arm or the second arm is supported against the front face of the side wall depending on the installation situation.

According to a further embodiment the first arm of the spacer is shorter than the second arm of the same.

The first arm can also be referred to as the short arm and the second arm as the long arm.

According to a further embodiment the mounting device also comprises a cover, which is configured separately from the pilaster strip support and is fastened to the pilaster strip support.

The cover is preferably U-shaped in cross section. The cover can be a sheet metal part. The cover can be suspended in or clipped into the pilaster strip support and/or can be screwed thereto.

According to a further embodiment the mounting device also comprises a covering fastened to the cover.

The covering can also be dispensed with. The covering forms a decorative surface of the mounting device.

According to a further embodiment the covering is designed to connect two adjacent covers of two domestic appliances.

To this end the covering is preferably mounted on two adjacent covers of two domestic appliances positioned next to one another.

According to a further embodiment the covering is made of glass, aluminum or plastic.

The covering can be colored and/or structured in any manner. For example the covering can be made from an aluminum profile.

According to a further embodiment the mounting device also comprises at least one cover element, which is fastened to the pilaster strip support and/or spacer.

The cover element is preferably a sheet metal part suspended in or clipped into the plaster strip support and/or spacer or screwed thereto.

According to a further embodiment a cover element can be arranged at the top and bottom of a door of the domestic appliance respectively.

Therefore two cover elements are preferably provided, forming a top and bottom termination of the door of the domestic appliance for the second installation situation.

According to a further embodiment the mounting device also comprises a fastening bracket for fastening the pilaster strip support to a side wall of the piece of furniture.

The fastening bracket can be connected to the side wall of the piece of furniture with the aid of a fastening element, in particular a screw.

A domestic appliance with such a mounting device is also proposed.

The domestic appliance can be a domestic cooking appliance, for example an oven, a microwave appliance or an oven with microwave function. The domestic appliance can also be a water-conducting domestic appliance, such as a dishwasher or washing machine.

According to one embodiment a mounting device is arranged on both sides of a receiving region of the domestic appliance respectively.

The front of the receiving region can be closed by a door. The receiving region can be an oven muffle of an oven.

Further possible implementations of the mounting device and/or domestic appliance also include combinations not specifically cited of features or embodiments described above or in the following in relation to the exemplary embodiments. The person skilled in the art will also add individual aspects to improve or supplement the respective basic form of the mounting device and/or domestic appliance.

Further advantageous configurations and aspects of the mounting device and/or domestic appliance are the subject matter of the subclaims as well as the exemplary embodiments of the mounting device and/or domestic appliance described in the following. The mounting device and/or domestic appliance is/are described in more detail below based on preferred embodiments with reference to the accompanying figures.

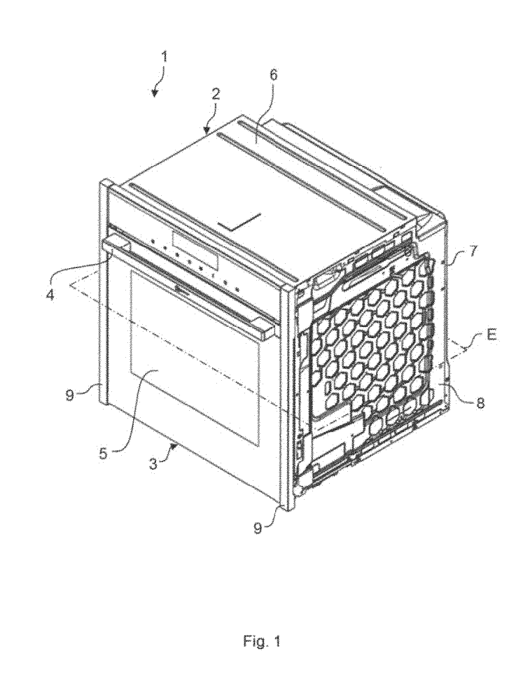

FIG. 1 shows a schematic perspective view of an embodiment of a domestic appliance;

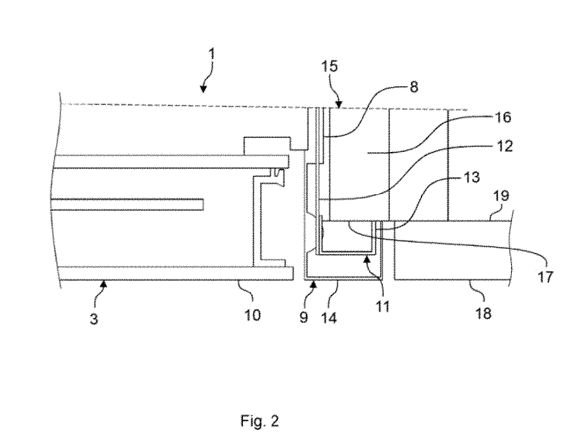

FIG. 2 shows a schematic partial sectional view of the domestic appliance along the sectional plane E in FIG. 1;

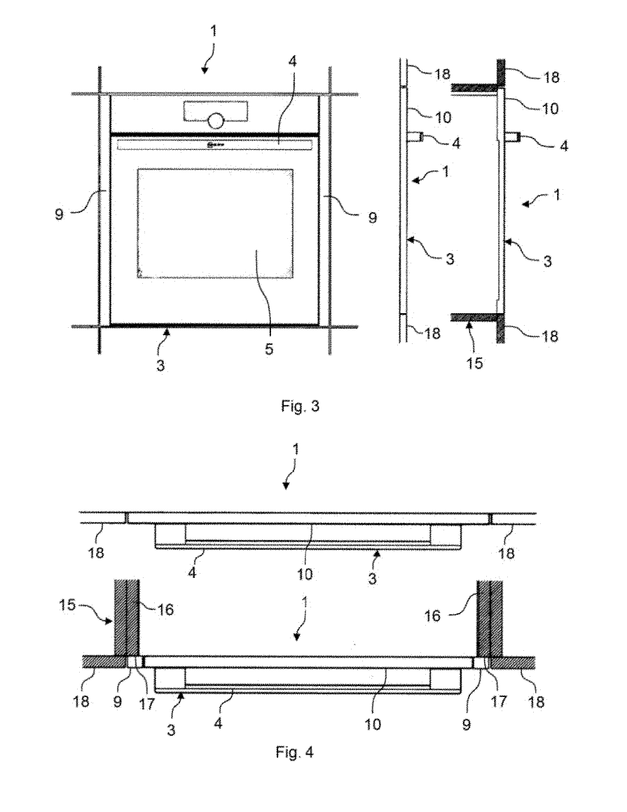

FIG. 3 shows a schematic front view, a schematic side view and a schematic sectional view of a further embodiment of a domestic appliance;

FIG. 4 shows a schematic top view and further schematic sectional view of the domestic appliance according to FIG. 3;

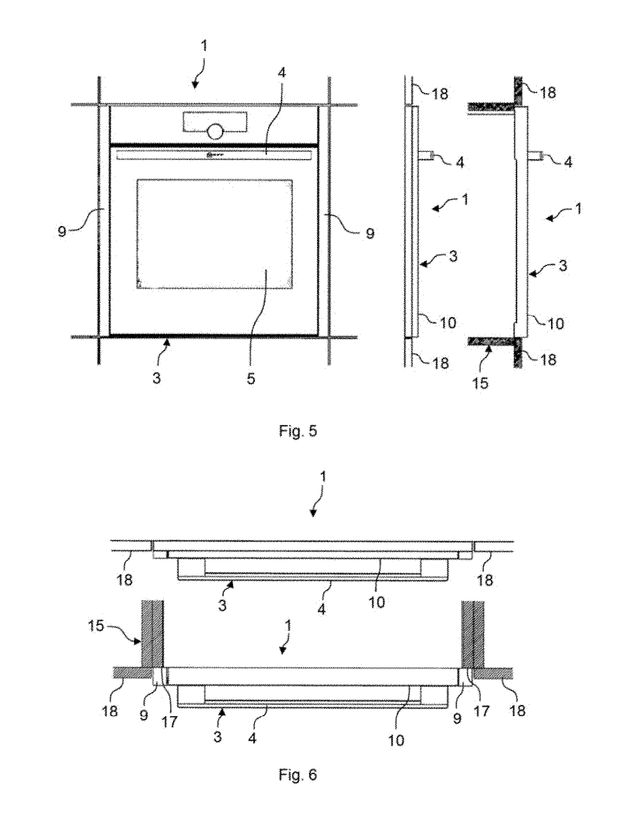

FIG. 5 shows a schematic front view, a schematic side view and a schematic sectional view of a further embodiment of a domestic appliance;

FIG. 6 shows a schematic top view and a further schematic sectional view of the domestic appliance according to FIG. 5;

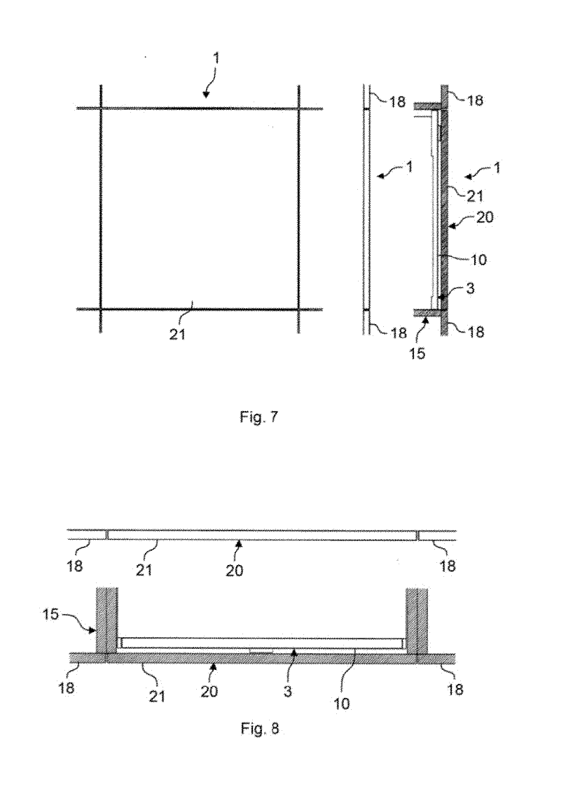

FIG. 7 shows a schematic front view, a schematic side view and a schematic sectional view of a further embodiment of a domestic appliance;

FIG. 8 shows a schematic top view and a further schematic sectional view of the domestic appliance according to FIG. 7;

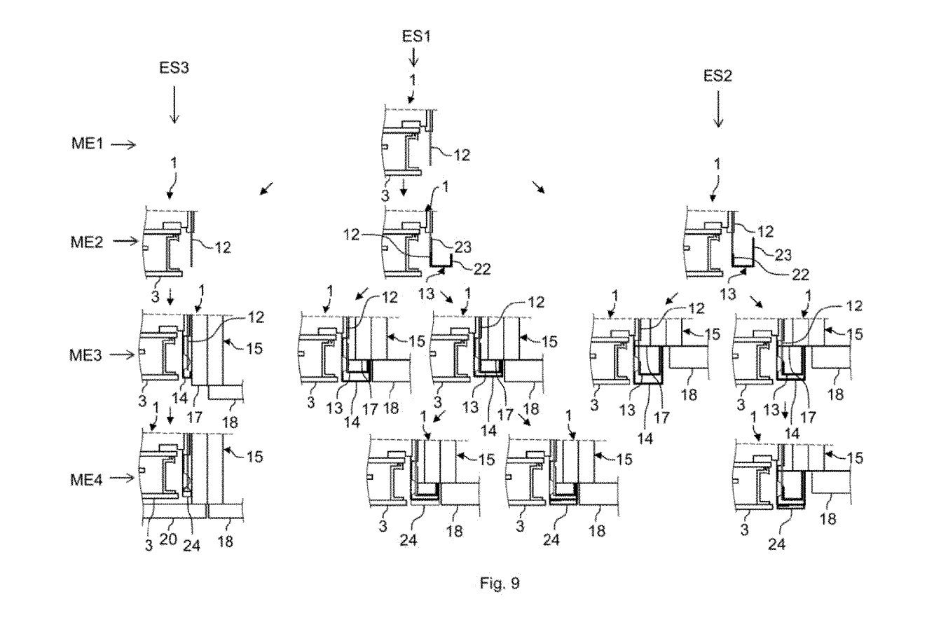

FIG. 9 shows different installation situations for a domestic appliance in a piece of furniture that can be achieved with the aid of a mounting device in table form;

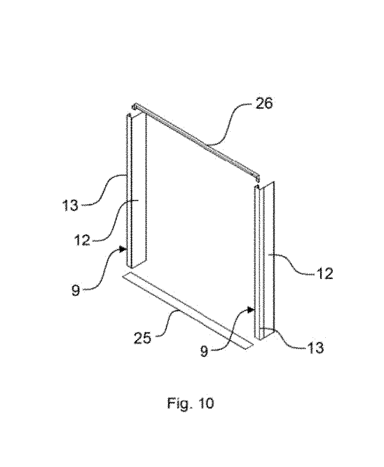

FIG. 10 shows a schematic perspective view of an embodiment of a mounting device for a domestic appliance;

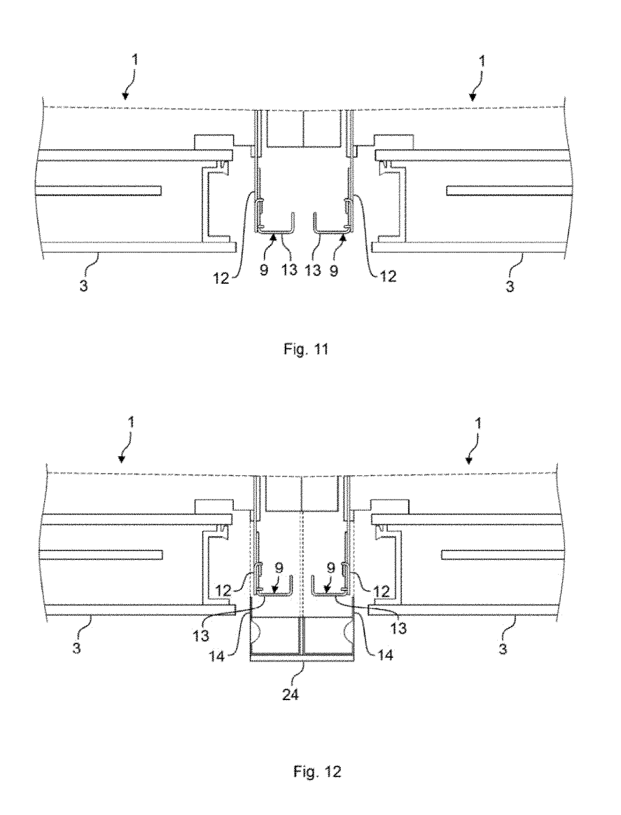

FIG. 11 shows a schematic sectional view of a further embodiment of a domestic appliance;

FIG. 12 shows a further schematic sectional view of the domestic appliance according to FIG. 11; and

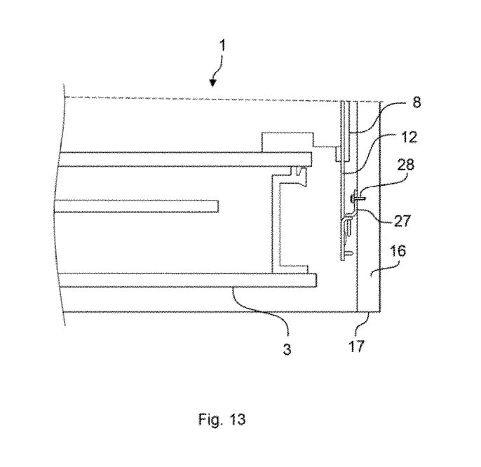

FIG. 13 shows a schematic partial sectional view of a further embodiment of a domestic appliance.

Identical elements or those of identical function are shown with the same reference characters in the figures, unless otherwise specified.

FIG. 1 shows a schematic perspective view of an embodiment of a domestic appliance 1. The domestic appliance 1 can be a domestic cooking appliance, for example an oven, a microwave appliance or an oven with microwave function. The domestic appliance 1 can also be a water-conducting domestic appliance, such as a dishwasher or washing machine. The domestic appliance 1 comprises a receiving region 2, for example an oven muffle, the front of which can be closed with the aid of a door 3. The door 3 is hinged to the receiving region 2 in such a manner that it can be pivoted at its lower end. The door 3 can also be hinged to the receiving region 2 at the side or can be attached to a carriage that can be pulled out of the receiving region 2. The door 3 comprises a handle 4 for opening and closing it and a viewing window 5. The receiving region 2 is box-shaped and comprises a base (not shown), a top 6 arranged opposite the base, a rear wall 7 arranged opposite the door 3 and two opposing side walls 8, only one of which is shown in FIG. 1.

The domestic appliance 1 is preferably a built-in appliance, which can be integrated into a piece of furniture, in particular a kitchen unit (not shown in FIG. 1). The domestic appliance 1 has a mounting device 9 for this purpose. The domestic appliance 1 is fastened to the piece of furniture with the aid of the mounting device 9. The mounting device 9 can therefore also be referred to as a fastening device. Such a mounting device 9 is preferably provided on both sides of the domestic appliance 1 respectively. The mounting device 9 is in the form of a batten and runs vertically in the orientation in FIG. 1.

FIG. 2 shows a schematic partial sectional view of the domestic appliance 1 along a sectional plane E shown in FIG. 1. As shown in FIG. 2, the door 3 has a front surface or front face 10. The mounting device 9 comprises a technical pilaster strip or support facility 11 with a pilaster strip support 12 and a spacer 13. The pilaster strip support 12 is connected to the side wall 8 of the receiving region 2, for example being suspended therein. The spacer 13 in turn is connected to the pilaster strip support 12. A decorative pilaster strip or cover 14 is provided at the front of the support facility 11. The cover 14 is connected to the pilaster strip support 12. Because the spacer 13 is a separate part, the spacer function can be removed from the pilaster strip support 12. The pilaster strip support 12 is identical for all types of domestic appliance 1, with the result that the installation situation can be defined separately with the spacer 13.

FIG. 2 also shows a piece of furniture 15, into which the domestic appliance 1 is built. The piece of furniture 15 comprises a side wall 16, which is arranged parallel to the side wall 8 of the receiving region 2. The side wall 16 has a front surface or front face 17. An arm of the U-shaped spacer 13 rests against the front face 17. The spacer 13 can thus define the distance between the cover 14 and the front face 17. The piece of furniture 15 has a front surface or front face 18, which is flush with a front face of the cover 14. The front face of the cover 14 is also arranged flush with the front face 10 of the door 3. The cover 14 can also protrude beyond the front face 18 or be set back from it. A rear face 19 of the piece of furniture 15 is provided facing away from the front face 18.

FIGS. 3 and 4 show an embodiment of a domestic appliance 1, in which the mounting device 9 and in particular the spacer 13 are configured in such a manner that the front face 10 of the door is arranged flush with the front face 18 of the piece of furniture 15. The flush arrangement is a first installation situation of the domestic appliance 1, which can be brought about with the aid of the mounting device 9.

FIGS. 5 and 6 show a further embodiment of a domestic appliance 1, in which the mounting device 9 and in particular the spacer 13 are configured in such a manner that the front face 10 of the door protrudes beyond the front face 18 of the piece of furniture 15, for example by 15 millimeters. The protruding arrangement is a second installation situation of the domestic appliance 1, which can be brought about with the aid of the mounting device 9.

FIGS. 7 and 8 show a further embodiment of a domestic appliance 1, in which the mounting device 9 and in particular the spacer 13 are configured in such a manner that the front face 10 of the door is set back behind the front face 18 of the piece of furniture 15. The required recess depth here is 570 millimeters. The set-back arrangement is a third installation situation of the domestic appliance 1, which can be brought about with the aid of the mounting device 9. The piece of furniture 15 here comprises a front panel 20, which is mounted on the door 3. A front surface or front face 21 of the front panel 20 is arranged flush with the front face 18 of the piece of furniture 15. The first installation situation can be referred to as “flush” or ES1, the second installation situation as “proud” or ES2 and the third installation situation as “hidden” or ES3.

FIG. 3 shows a tabular overview of the three installation situations ES1 to ES3 and how these can be brought about with the aid of the construction kit mounting device 9. In the orientation in FIG. 9 the third installation situation ES3 is on the left, the first installation situation ES1 is in the center and the second installation situation ES2 is on the right. The mounting device 9 has a number of mounting planes ME1 to ME4. A first mounting plane ME1 is identical for all installation situations ES1 to ES3. The first mounting plane ME1 comprises the pilaster strip support 12, which is provided on both sides of the receiving region 2 and connected to the respective side wall 8. The pilaster strip support 12 is used for all installation situations ES1 to ES3. The first mounting plane ME1 can also be referred to as the pilaster strip support plane.

An adapter plane or second mounting plane ME2 of the mounting device 9 comprises the spacer 13 depending on the installation situation ES1 to ES3. In the third installation situation ES3 the mounting device 9 does not have a spacer 13. In the first installation situation ES1 and the second installation situation ES2 the mounting device 9 comprises a spacer 13, mounted differently in each instance. The U-shaped spacer 13 has a short or first arm 22 and a long or second arm 23. In the first installation situation ES1 the spacer 13 is mounted in such a manner that the second arm 23 is connected to the pilaster strip support 12 and the first arm 22 rests against the front face 17 of the piece of furniture 15. In the second installation situation ES2 the spacer 13 is mounted in the opposite manner, so that the first arm 22 is mounted on the pilaster strip support 12 and the second arm 23 rests against the front face of the piece of furniture 15.

A pilaster strip plane or third mounting plane ME3 can respectively comprise a suitable cover 14. With the first installation situation ES1 the cover 14 can be flush with the front face 18 of the piece of furniture 15 and the door 3. In the first installation situation ES1 the cover 14 can also be set back behind the front face 18 and the door 3. The cover 14 can also be set back behind the door 3 in the second installation situation ES2.

A covering plane or fourth mounting plane ME4 can comprise a covering 24. In the third installation situation ES3 the covering 24 can be a plastic covering, which is attached to the cover 14. With the first installation situation SE1 the covering 24 can be a covering with an aluminum profile as shown on the left in the orientation in FIG. 9 or a covering with glass as shown on the right in the orientation in FIG. 9. In the first installation situation ES1 the covering 24 produces a flush arrangement of the door 3, covering 24 and front face 18 of the piece of furniture 15. With the second installation situation ES2 the mounting device 9 also comprises a covering 24 configured as an aluminum profile. The covering 24 is positioned so that it is flush with the door 3 and protrudes beyond the front face 18 of the piece of furniture 15.

For the second installation situation ES2, as shown in FIG. 10, cover elements 25, 26 can be provided at the top and bottom of the door 3. The cover elements 25, 26 can be connected to the pilaster strip supports 12 and/or spacers 13. As shown in FIGS. 11 and 12, two mounting devices 9 arranged next to one another can have a shared covering 24. As shown in FIG. 13, in the third installation situation ES3 the pilaster strip support 12 can be connected to the side wall 16 of the piece of furniture 15 with the aid of a fastening bracket 27. A fastening element 28, for example a screw, can be provided for this purpose.

The present invention has been described with reference to exemplary embodiments but it can be modified in many different ways.

### REFERENCE CHARACTERS USED

1 Domestic appliance
2 Receiving region
3 Door
4 Handle
5 Viewing window
6 Top
7 Rear wall
8 Side wall
9 Mounting device
10 Front face
11 Support facility
12 Pilaster strip support
13 Spacer
14 Cover
15 Piece of furniture
16 Side wall
17 Front face
18 Front face
19 Rear face
20 Front panel
21 Front face
22 Arm
23 Arm
24 Covering
25 Cover element
26 Cover element
27 Fastening bracket
28 Fastening element
E Sectional plane
ES1 Installation situation
ES2 Installation situation
ES3 Installation situation
ME1 Mounting plane
ME2 Mounting plane
ME3 Mounting plane
ME4 Mounting plane

1-15. (canceled)

16. A mounting device for mounting a domestic appliance in or on a piece of furniture, said mounting device being configured to selectively mount the domestic appliance in or on the piece of furniture in one of three ways, a first way in which the mounting device mounts the domestic appliance in a first installation situation, in which the mounting device is arranged flush with a front face of the piece of furniture, a second way in which the mounting device mounts the domestic appliance in a second installation situation, in which the mounting device protrudes beyond the front face of the piece of furniture, a third way in which the mounting device mounts the domestic appliance in a third installation situation, in which the mounting device is set back behind the front face of the piece of furniture.

17. The mounting device of claim 16, comprising a pilaster strip support capable of being fastened to a side wall of a receiving region of the domestic appliance.

18. The mounting device of claim 17, further comprising a spacer configured separately from the pilaster strip support to distance the domestic appliance from the piece of furniture.

19. The mounting device of claim 18, wherein the spacer is U-shaped and includes a first arm and a second arm, the second arm being connected to the pilaster strip support in the first installation situation and the first arm being connected to the pilaster strip support in the second installation situation.

20. The mounting device of claim 19, wherein in the first installation situation the first arm of the spacer rests against a front face of a side wall of the piece of furniture, and wherein in the second installation situation the second arm of the spacer rests against the front face of the side wall of the piece of furniture.

21. The mounting device of claim 19, wherein the first arm of the spacer is sized shorter than the second arm of the spacer.

22. The mounting device of claim 17, further comprising a cover configured separately from the pilaster strip support and fastened to the pilaster strip support.

23. The mounting device of claim 22, further comprising a covering fastened to the cover.

24. The mounting device of claim 23, wherein the covering is configured to connect the cover to an adjacent cover of another said mounting device.

25. The mounting device of claim 23, wherein the covering is made of glass, aluminum or plastic.

26. The mounting device of claim 18, further comprising a cover element which is fastened to at least one of the pilaster strip support and the spacer.

27. The mounting device of claim 16, further comprising two cover elements arranged at a top and a bottom of a door of the domestic appliance, respectively.

28. The mounting device of claim 17, further comprising a fastening bracket configured to fasten the pilaster strip support to a side wall of the piece of furniture.

29. A household appliance, comprising a mounting device, said mounting device being configured to selectively mount the domestic appliance in or on the piece of furniture in one of three ways, a first way in which the mounting device mounts the domestic appliance in a first installation situation, in which the mounting device is arranged flush with a front face of the piece of furniture, a second way in which the mounting device mounts the domestic appliance in a second installation situation, in which the mounting device protrudes beyond the front face of the piece of furniture, a third way in which the mounting device mounts the domestic appliance in a third installation situation, in which the mounting device is set back behind the front face of the piece of furniture.

30. The household appliance of claim 29, wherein the mounting device comprises a pilaster strip support capable of being fastened to a side wall of a receiving region of the domestic appliance.

31. The household appliance of claim 30, wherein the mounting device comprises a spacer configured separately from the pilaster strip support to distance the domestic appliance from the piece of furniture.

32. The household appliance of claim 31, wherein the spacer is U-shaped and includes a first arm and a second arm, the second arm being connected to the pilaster strip support in the first installation situation and the first arm being connected to the pilaster strip support in the second installation situation.

33. The household appliance of claim 32, wherein in the first installation situation the first arm of the spacer rests against a front face of a side wall of the piece of furniture, and wherein in the second installation situation the second arm of the spacer rests against the front face of the side wall of the piece of furniture.

34. The household appliance of claim 32, wherein the first arm of the spacer is sized shorter than the second arm of the spacer.

35. The household appliance of claim 30, wherein the mounting device comprises a cover configured separately from the pilaster strip support and fastened to the pilaster strip support.

36. The household appliance of claim 35, wherein the mounting device comprises a covering fastened to the cover.

37. The household appliance of claim 36, wherein the covering is configured to connect the cover to an adjacent cover of another said mounting device.

38. The household appliance of claim 36, wherein the covering is made of glass, aluminum or plastic.

39. The household appliance of claim 31, wherein the mounting device comprises a cover element which is fastened to at least one of the pilaster strip support and the spacer.

40. The household appliance of claim 29, wherein the mounting device comprises two cover elements arranged at a top and a bottom of a door of the domestic appliance, respectively.

41. The household appliance of claim 30, wherein the mounting device comprises a fastening bracket configured to fasten the pilaster strip support to a side wall of the piece of furniture.

42. The household appliance of claim 29, further comprising two of said mounting device arranged on both sides of a receiving region of the domestic appliance respectively.
